(19) United States
(12) Patent Application Publication
(10) Pub. No.: US 2026/0032519 A1
(43) Pub. Date: Jan. 29, 2026

(54) QOS FLOW CONTROL METHOD, APPARATUS, AND COMPUTER STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 18/996,919

(22) PCT Filed: Jul. 25, 2022
(86) PCT No.: PCT/CN2022/107723

§ 371 Date: Jan. 17, 2025

(51) Int. Cl. H04W 28/24; H04W 56/00; H04W 60/04

(52) U.S. Cl. CPC H04W 28/24; H04W 56/0015; H04W 60/04

(57) ABSTRACT

A method for quality of service (QoS) flow control dynamically optimizes network resource allocation based on terminal power consumption status. An access network function receives terminal status information from an application function (AF) and determines a QoS profile for associated QoS flows from alternative profiles. The selected QoS profile is transmitted to a core network function or terminal for QoS updates. The terminal status information, which may include battery level, CPU load, or overheating status, informs the selection process to balance performance and efficiency. Core network functions manage QoS updates by interacting with the AF, access network, and terminals. The method, apparatus and computer readable medium ensure adaptive and energy-efficient QoS management for improved user experience and resource utilization in diverse network environments.

### CROSS REFERENCE TO RELATED APPLICATIONS

The present application is a U.S. national phase of International Application No. PCT/CN2022/107723, filed on Jul. 25, 2022, the disclosure of which is incorporated herein by reference in its entirety.

### TECHNICAL FIELD

The present disclosure relates to the field of wireless communication technology, and in particular to quality of service (QoS) flow control methods and apparatuses, and a computer storage medium.

### BACKGROUND

In the fifth generation mobile networks (5G) technology, mobile media services, cloud extended reality (XR), cloud games, remote control of machines or drones based on video and the like are expected to contribute more and more traffic to 5G networks.

At present, due to high throughput, low latency, and high reliability requirements of XR and media services, high power consumption on the terminal side is required, and a battery level of the terminal may affect the user experience.

So, matching service traffic characteristics with terminal energy consumption management is an urgent problem that needs to be solved.

### SUMMARY

The present disclosure provides quality of service (QoS) flow control methods and apparatuses, and a computer storage medium to match service traffic characteristics with terminal energy consumption management, thereby ensuring service requirements and user experience.

According to a first aspect of the present disclosure, there is provided a QoS flow control method, which can be applied to an access network function entity in a communication system. The method can include: receiving, by an access network function entity, terminal status information (UE status information) from an application function (AF) entity, where the terminal status information is configured to represent a power consumption status of a terminal; determining, by the access network function entity, a first QoS profile for one or more QoS flows associated with the terminal from one or more alternative QoS profiles according to the terminal status information; and sending, by the access network function entity, the first QoS profile to a first core network function entity, where the first QoS profile is configured for at least one of the terminal, the first core network function entity, a second core network function entity, or the AF entity to perform a QoS update.

According to a second aspect of the present disclosure, there is provided a QoS flow control method, which can be applied to a second core network function entity in a communication system. The method can include: receiving, by the second core network function entity, terminal status information from an application function (AF) entity, where the terminal status information is configured to represent a power consumption status of a terminal; and sending, by the second core network function entity, the terminal status information to a first core network function entity or a third core network function entity, where the terminal status information is further configured for an access network function entity to determine a first QoS profile for one or more QoS flows associated with the terminal from one or more alternative QoS profiles.

According to a third aspect of the present disclosure, there is provided a QoS flow control method, which can be applied to a first core network function entity in a communication system. The method can include: receiving, by the first core network function entity, a first QoS profile sent by an access network function entity, where the first QoS profile is a QoS profile for one or more QoS flows associated with a terminal determined by the access network function entity from one or more alternative QoS profiles according to terminal status information of the terminal; and performing, by the first core network function entity, at least one of: performing a QoS update on the one or more QoS flows associated with the terminal according to the first QoS profile; sending the first QoS profile to a second core network function entity, where the first QoS profile is configured for the second core network function entity and/or an application function (AF) entity to perform a QoS update; or sending the first QoS profile to the terminal, where the first QoS profile is further configured for the terminal to perform a QoS update.

According to a fourth aspect of the present disclosure, there is provided a communication apparatus, such as an access network function entity, a first core network function entity, a third core network function entity, a fourth core network function entity, and an application function (AF) entity. The communication apparatus can include a memory and one or more processors, where the one or more processors are connected to the memory and configured to execute computer executable instructions stored on the memory to implement the QoS flow control method as described in the first to third aspects and any possible implementation thereof.

According to a fifth aspect of the present disclosure, there is provided a computer readable storage medium storing instructions which, when run on a computer, implement the QoS flow control method as described in the first to third aspects and any possible implementation thereof.

In the present disclosure, the UE status information of the UE is provided to the access network function entity through the AF entity, so that the access network function entity can match service traffic characteristics and terminal energy consumption management according to the UE status information, that is, select the corresponding QoS profile according to the power consumption status of the terminal, so as to ensure service requirements and user experience. Furthermore, the UE status information provided by the AF as additional information for policy determination can reduce the use of wireless interface network resources, especially in situations where resources are limited. Further, the UE status information of the UE is provided to the access network function entity through the AF entity, which can support the use of network resources according to capabilities of the terminal. Further, the UE status information of the UE is provided to the access network function entity through the AF entity, so that the user's critical application programs are allowed to run in the power saving mode, thereby improving the user experience and prolonging the battery life, instead of completely shutting down

### BRIEF DESCRIPTION OF THE DRAWINGS

FIG. 1 is a schematic architectural diagram of a 5G communication system according to an embodiment of the present disclosure.

FIG. 2 is a schematic diagram of an implementation procedure of a first quality of service (QoS) flow control method according to an embodiment of the present disclosure.

FIG. 3 is a schematic diagram of an implementation procedure of a second QoS flow control method according to an embodiment of the present disclosure.

FIG. 4 is a schematic diagram of an implementation procedure of a third QoS flow control method according to an embodiment of the present disclosure.

FIG. 5 is a schematic diagram of an implementation procedure of a fourth QoS flow control method according to an embodiment of the present disclosure.

FIG. 6 is a schematic diagram of a service specific information provisioning procedure according to an embodiment of the present disclosure.

FIG. 7 is a schematic diagram of setting up an application function (AF) session with required QoS procedure according to an embodiment of the present disclosure.

FIG. 8 is a schematic diagram of a packet data unit (PDU) session modification procedure according to an embodiment of the present disclosure.

FIG. 9 is a schematic structural diagram of a communication apparatus according to an embodiment of the present disclosure.

FIG. 10 is a schematic structural diagram of a communication apparatus according to an embodiment of the present disclosure.

FIG. 11 is a schematic structural diagram of a network function entity according to an embodiment of the present disclosure.

### DETAILED DESCRIPTION OF THE EMBODIMENTS

The exemplary embodiments will be described in detail herein, and examples thereof are shown in the accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a,” “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, and the like may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of,” “when” or “in response to determining”.

Further, in the description of the embodiments of the present disclosure, “and/or” is only an association relationship for describing associated objects, indicating that three relationships can exist. For example, A and/or B can mean: A exists alone, A and B exist simultaneously, and B exists alone. In addition, in the description of the embodiments of the present disclosure, “a plurality of” may refer to two or more than two.

The technical solution of the embodiments of the present disclosure relates to an architecture of a communication system. The communication system can be a fifth generation mobile networks (5G) communication system or a future evolved communication system. In the architecture of the communication system, there are a terminal, an access network function entity (also described as an access network function, an access network element, an access network function component, an access network function module, etc.), and at least one core network function entity (also described as core network function, core network device, core network element, core network function component, core network function module, etc.). The at least one core network function entity is located in a core network (for example, 5GC). The terminal is used to report terminal status information (user equipment (UE) status information) for indicating its own power consumption status to the core network side. The at least one core network function entity has at least the following functions: providing received terminal status information to the access network function entity, receiving a first QoS profile determined by the access network function entity for one or more QoS flows associated with the terminal according to the terminal status information, performing a QoS update on the one or more QoS flows associated with the terminal according to the received first QoS profile, and sending the first QoS profile to a next level core network function entity for the next level core network function entity to perform a QoS update on the one or more QoS flows associated with the terminal. In practical applications, the above QoS flows are QoS flows of a first service of the terminal. The first service can include an extended reality (XR) service, a mobile media service and the like. The XR service and the mobile media service can also be referred to as an XRM service or described as an XR\M service.

Hereinafter, the embodiments of the present disclosure will be explained and illustrated by taking the 5G communication system as an example. It should be noted that the embodiments of the present disclosure are also applicable to any future evolved communication system after the 5G communication system, and the embodiments of the present disclosure do not specifically limit this.

FIG. 1 is a schematic architectural diagram of a 5G communication system according to an embodiment of the present disclosure. Referring to FIG. 1, the above 5G communication system 100 can include a 5G radio access network (RAN) and a 5G core network (5GC). The 5G radio access network can include a next generation radio access network (NG RAN). The NG RAN 101 communicates with the terminal (or can be referred to as terminal device) 102 via a Uu interface. The 5G core network can include the above at least one core network function entity, for example, an access and mobility management function (AMF) entity 1031, a session management function (SMF) entity 1032, a policy control function (PCF) entity 1033, a user plane function (UPF) entity 1034, an application function (AF) entity 1035, a network exposure function (NEF) entity 1036, a time sensitive communication and time synchronization function (TSCTSF) entity 1037, etc. In the embodiment of the present disclosure, the above communication system can also include other network function entities (also referred to as network elements, network devices, etc.), which is not specifically limited in the embodiments of the present disclosure.

It should be noted that in FIG. 1, both a third-party (3rd) AF entity and an operator AF entity belong to the AF entity. The difference is that the third-party AF entity (for example, an instant messaging service server, an electronic payment service server, etc.) is not controlled by operators, and the operator AF entity (for example, a proxy-call session control function (P-CSCF) entity in an IP multimedia system) is controlled by operators. The third-party AF entity needs to interact with the PCF entity through the NEF entity. The above operator AF entity can also be described as a trusted AF entity, and the above third-party AF can also be described as an untrusted AF entity.

In addition, in order to make the description more concise, the “entity” in each function entity will be removed in the subsequent description. For example, the PCF entity is abbreviated as the PCF, the SMF entity is abbreviated as the SMF, and other entities are similar and will not be listed one by one.

In an embodiment of the present disclosure, in the above 5G communication system 100, the following interfaces can be set between various core network function entities.

N3: a communication interface between the UPF 1034 and the NG RAN 101.

N4: an interface between the SMF 1032 and the UPF 1034, which is used to transmit information between a control plane and a user plane (UP), including issuance of forwarding rules of the control plane to the UP, QoS control rules, traffic statistics rules, etc., and information reporting of the UP.

N2: an interface between the AMF 1031 and the NG RAN 101, which is used to transmit radio bearer control information and the like from the core network side to the NG RAN 101.

N1: an interface between the AMF 1031 and the terminal 102, which is unrelated to access, and is used to transmit QoS control rules and the like to the terminal 102.

In FIG. 1, any two entities among the NEF, the PCF, the TSCTSF, the AMF, and the SMF can perform service-oriented communication with each other. For example, interfaces Nnef and Npcf used for communication between the NEF and the PCF are both service-oriented interfaces. Similarly, interfaces Naf, Ntsctsf, Namf, and Nsmf are service-oriented interfaces.

The above terminal can be a terminal device with a wireless communication function and a wireless sensing function, and can also be called user equipment (UE). The terminal can be deployed on land, including indoors or outdoors, handheld, wearable or vehicle-mounted. The terminal can also be deployed on water (for example, ships, etc.). The terminal can also be deployed in the air (for example, aircraft, balloons, satellites, etc.). The terminal may be a mobile phone, a tablet computer, a computer with a wireless transceiver function, a virtual reality (VR) terminal device, an augmented reality (AR) terminal device, or a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, etc. The terminal may also be a handheld device, a vehicle-mounted device, a wearable device, a computing device having a wireless communication function and a wireless sensing function, or other processing device connected to a wireless modem, etc. Optionally, the terminal device can also be called by different names in different networks, for example, terminal device, access terminal, subscriber unit, subscriber station, mobile station, mobile table, remote station, remote terminal, mobile device, user terminal, terminal, wireless communication device, user agent or user apparatus, cellular telephone, cordless telephone, session initiation protocol (SIP) telephone, wireless local loop (WLL) station, personal digital assistant (PDA), terminal in 5G network or future evolved network, etc.

The above access network function entity can be a function entity used by the access network side to support communication terminals access the wireless communication system. For example, the access network function entity can be a next generation access network function entity (for example, next generation NodeB, gNB), a transmission reception point (TRP), a relay node, an access point (AP) and the like in the 5G communication system.

It should be noted that in the communication system shown in FIG. 1, the various function entities and interfaces are only exemplary, and not all functions are necessary when the various function entities are applied to the embodiments of the present disclosure. The function entities of the access network and the core network can be physical devices or virtualized devices, which is not limited herein. The communication system in the embodiment of the present disclosure may also include other devices not shown in FIG. 1, which is not limited herein.

In the 5G network, mobile media services, XR, cloud games, remote control of machines or drones based on video and the like are expected to contribute more and more traffic to the 5G network, especially XR and media (XRM) services. The XRM services have characteristics of high throughput, low latency and high reliability requirements, which require high power consumption on the terminal side, and a battery level of the terminal may affect the user experience.

At present, based on the existing terminal implementation and considering service traffic characteristics, terminal power saving enhancement schemes have been defined in 3GPP. For example, power saving modes of the terminal in different connection managements (CMs), such as a CM-IDLE (idle state) power saving mode and a CM-CONNECTED (connected) power saving mode in a radio resource control (RRC) inactive state, a mobile initiated connection only (MICO) mode, an extended discontinuous reception (eDRX) mode and the like are also defined. However, the above schemes are specially designed for Internet of Things (IoT) terminals with ultra-low power consumption. If these schemes are used on smartphones, the user experience will be greatly affected.

Therefore, how to match service traffic characteristics with terminal energy consumption management is an urgent problem to be solved.

In the embodiments of the present disclosure, in the following embodiments, the terminal device in the communication system can take a UE as an example, a first core network function entity can take an SMF as an example, a second core network function entity can take a PCF as an example, a third core network function entity can take an AMF as an example, a fourth core network function entity can take other PCF as an example, and the application function (AF) entity can take an AF as an example to explain QoS flow control methods proposed in the embodiments of the present disclosure. In the 5G communication system and its evolved versions, the terminal, the access network function entity, the first core network function entity, the second core network function entity, the third core network function entity, the fourth core network function entity, and the AF entity may also be other function entities with the same or similar functions and connection relationships, which is not limited in the embodiments of the present disclosure.

In order to solve the above problems, in combination with the above communication system, an embodiment of the present disclosure provides a QoS flow control method.

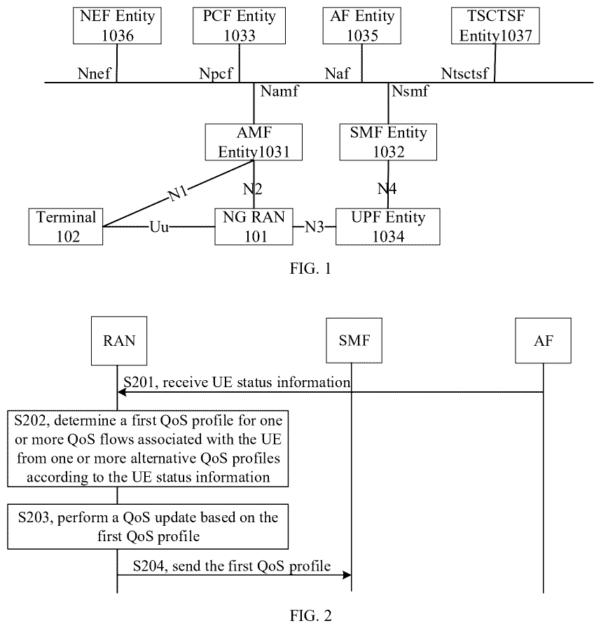

FIG. 2 is a schematic diagram of an implementation procedure of a first QoS flow control method according to an embodiment of the present disclosure. As shown in FIG. 2, in this embodiment, the method is applied to an access network function entity (for example, a RAN) side, and the method can include S201 to S204.

In S201, the access network function entity receives terminal status information (UE status information) from an application function entity (for example, an AF).

The UE status information is used to represent a power consumption status of the UE. For example, the UE status information includes one or more parameters related to UE performance. For example, the UE status information may include at least one of the following: a UE battery level, a UE battery life, a UE powered mode, a UE central processing unit (CPU) load, a UE overheating status. In an embodiment of the present disclosure, parameters related to UE power consumption may include others. Here, the UE powered mode can include a battery-powered mode and a mains/wall-powered mode. Here, the battery-powered mode refers to using a built-in battery of the UE for power supply, and the mains/wall-powered mode refers to using a power adapter to connect to, for example, a wall socket, a mobile socket or the like, so as to connect to a power source to supply power to the UE.

It should be understood that a registered UE can report its UE status information to the AF through an application layer, and then the AF reports the UE status information to a PCF. The PCF sends the UE status information to the access network function entity through an AMF or an SMF.

It should be noted that the above S201 can be multiplexed with a service specific information provisioning procedure, a setting up an AF session with required QoS procedure, and the like. The above S201 can also be multiplexed in other procedures, which is not specifically limited in the embodiments of the present disclosure. For example, S201 can be a Nnef_XRMServiceParameter service, a Nnef_AFsessionWithQoS_Create request, etc.

In S202, the access network function entity determines a first QoS profile for one or more QoS flows associated with the UE from one or more alternative QoS profiles according to the UE status information.

Here, the QoS profile can also be understood as a QoS level, and the QoS profile corresponds to the QoS level one by one.

It can be understood that the PCF can send one or more alternative QoS profiles to the access network function entity. After receiving the UE status information of the UE, the access network function entity can select a QoS profile (i.e., the first QoS profile) for the one or more QoS flows associated with the UE from the one or more alternative QoS profiles according to the power consumption status of the UE, and perform a QoS update according to the QoS profile.

Here, the one or more QoS flows associated with the UE can be related to a first service. In an embodiment of the present disclosure, the first service may be an XRM service, an XRM service group, or a multiple data service.

In some possible implementations, the above QoS flows may be of different granularities, for example, QoS flows for sessions (i.e., session QoS flows), QoS flows for services (e.g., service QoS flows), which are not specifically limited in the embodiments of the present disclosure.

It can be understood that the access network function entity can determine the corresponding QoS profile for one or more sessions of a service (i.e., the first service) of the UE according to the UE status information. Or, the PCF can determine the corresponding QoS profile for a service (i.e., the first service) of the UE according to the UE status information. Here, “determine” can be described as “set,” “generate,” “update,” etc.

In some possible implementations, the one or more alternative QoS profiles mentioned above may include at least one of the following: a packet delay budget, a packet error rate, an uplink (UL) guaranteed bitrate, a downlink (DL) guaranteed bitrate, an averaging window, a maximum data burst volume, or a terminal status management indication. The terminal status management indication is configured to indicate whether the one or more alternative QoS profiles support application to terminal status management.

It can be understood that the above packet delay budget refers to a packet delay budget corresponding to the one or more alternative QoS profiles. The above packet error rate refers to a packet error rate corresponding to the one or more alternative QoS profiles. The above uplink guaranteed bitrate refers to an uplink guaranteed bitrate corresponding to the one or more alternative QoS profiles. The above downlink guaranteed bitrate refers to a downlink guaranteed bitrate corresponding to the one or more alternative QoS profiles. The above averaging window refers to an averaging window corresponding to the one or more alternative QoS profiles. The above maximum data burst volume refers to a maximum data burst volume corresponding to the one or more alternative QoS profiles. The above terminal status management indication is information indicating whether the one or more alternative QoS profiles are used for terminal status management.

It should be noted that in an embodiment of the present disclosure, QoS parameters (for example, alternative QoS parameter sets) in the alternative QoS profiles defined in the existing communication protocol are extended, so that extended alternative QoS profiles can be applied to both guaranteed bit rate (GBR) QoS flows and non GBR QoS flows.

In practical applications, the PCF can indicate to the access network function entity information on whether the one or more alternative QoS profiles are used for terminal status management by carrying a terminal status management indication in the one or more alternative QoS profiles. For example, carrying a terminal status management indication in the one or more alternative QoS profiles indicates information that the one or more alternative QoS profiles are used for terminal status management, and carrying no terminal status management indication in the one or more alternative QoS profiles indicates information that the one or more alternative QoS profiles are not used for terminal status management. Or, the PCF can indicate to the access network function entity information on whether the one or more alternative QoS profiles are used for terminal status management through a value of the terminal status management indication. For example, if the value of the terminal status management indication is a first value, it indicates information that the one or more alternative QoS profiles are used for terminal status management; if the value of the terminal status management indication is a second value, it indicates information that the one or more alternative QoS profiles are not used for terminal status management. The PCF can also adopt other manners to set the terminal status management indication, which is not specifically limited in the embodiments of the present disclosure.

Accordingly, in S202, after receiving the one or more alternative QoS profiles, the access network function entity can determine whether the one or more alternative QoS profiles are used for terminal status management according to the terminal status management indication, and then determine a QoS profile for the one or more QoS flows associated with the UE from one or more alternative QoS profiles used for terminal status management according to the UE status information.

In some possible implementations, the PCF can send one or more alternative QoS profiles used for terminal status management to the access network function entity. Upon receiving these alternative QoS profiles, the access network function entity will know that the received alternative QoS profiles are used for terminal status management and then perform S202.

In some possible implementations, the PCF can send the one or more alternative QoS profiles in a form of a list (for example, alternative QoSs) to the access network function entity.

In other possible implementations, in S202, the access network function entity may also determine the first QoS profile according to the UE status information and an association relationship between UE status information and QoS profiles.

It can be understood that the access network function entity or the PCF can configure the association relationship between the UE status information and the QoS profiles. In S202, the access network function entity can determine the QoS profile for the one or more QoS flows associated with the UE according to the UE status information from the AF by querying the association relationship between the UE status information and the QoS profiles.

In some possible implementations, the PCF can send the association relationship between the UE status information and the QoS profiles to the access network function entity. Or, the access network function entity can configure the above association relationship according to a local policy and/or an operator policy. The access network function entity can also obtain the above association relationship in other ways, which is not specifically limited in the embodiments of the present disclosure.

In S203, the access network function entity performs a QoS update based on the first QoS profile.

It can be understood that the access network function entity, after determining the corresponding first QoS profile according to the power consumption status of the UE, performs a QoS update on the one or more QoS flows associated with the UE by using the first QoS profile.

In S204, the access network function entity sends the first QoS profile to the SMF.

It can be understood that in order to unify QoS control, the access network function entity can send the first QoS profile to the UE, the 5GC (including the SMF and/or the PCF), and the AF after determining the first QoS profile. For example, the access network function entity can send the first QoS profile to the UE, the 5GC (including the SMF and/or the PCF), and the AF by initiating a packet data unit (PDU) session modification procedure. In the PDU session modification procedure, the access network function entity first sends the first QoS profile to the SMF, then the SMF sends it to the PCF, and the PCF sends the received first QoS profile to the AF. In addition, the SMF can also send the first QoS profile to the UE. After receiving the first QoS profile, the UE, the PCF, and the AF can perform a QoS update according to the first QoS profile.

In some possible implementations, when sending the first QoS profile to the PCF through the SMF in S204, the access network function entity can also send the UE status information corresponding to the first QoS profile (i.e., the UE status information from the AF) to the PCF, so that the PCF can decide whether the first QoS profile is suitable for the current power consumption status of the UE based on the latest UE status information received by itself and the UE status information sent by the access network function entity, and determine whether to provide a more suitable alternative QoS profile to the access network function entity, adjust QoS policies, etc., thereby optimizing QoS control.

For example, in S204, the access network function entity sends the first QoS profile to the SMF through a non access stratum (NAS) message (for example, N2 SM information).

It should be noted that the above S203 and S204 can be executed simultaneously, or S203 can be executed first and then S204 is executed, which is not specifically limited in the embodiments of the present disclosure.

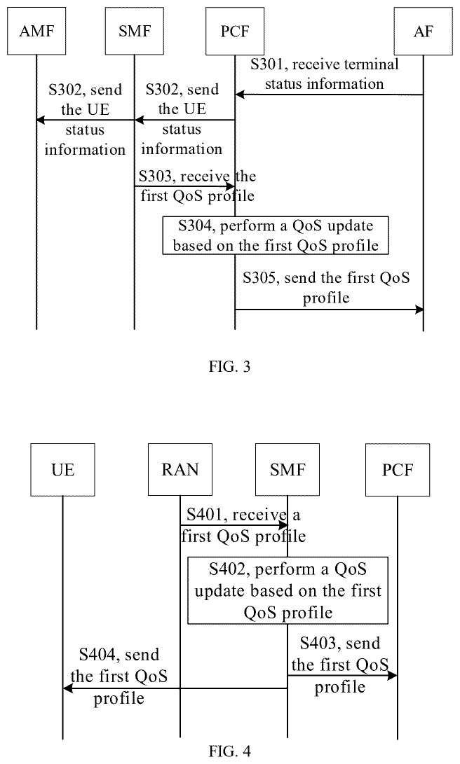

FIG. 3 is a schematic diagram of an implementation procedure of a second QoS flow control method according to an embodiment of the present disclosure. As shown in FIG. 3, in this embodiment, the method is applied to a second core network function entity (for example, a PCF) side, and the method can include S301 to S305.

In S301, the PCF receives terminal status information (UE status information) from an application function entity (for example, an AF).

The UE status information is used to represent a power consumption status of the UE. For example, the UE status information includes one or more parameters related to UE performance. For example, the UE status information may include at least one of the following: a UE battery level, a UE battery life, a UE powered mode, a UE CPU load, a UE overheating status. In an embodiment of the present disclosure, parameters related to UE power consumption may include others. Here, the UE powered mode can include a battery-powered mode and a mains/wall-powered mode. Here, the battery-powered mode refers to using a built-in battery of the UE for power supply, and the mains/wall-powered mode refers to using a power adapter to connect to, for example, a wall socket, a mobile socket or the like, so as to connect to a power source to supply power to the UE.

It should be understood that a registered UE can report its UE status information to the AF through an application layer, and then the AF reports the UE status information to a PCF.

In some possible implementations, the AF can, and is not limited to, send the UE status information to the PCF through the following paths.

In a first path, the AF directly sends the UE status information to the PCF. It can be understood that the AF can send the UE status information to the PCF through Naf and Npcf. In this case, the AF is a trusted AF.

In a second path, the AF sends the UE status information to the PCF through a NEF. It can be understood that the AF can send the UE status information to the NEF through Naf and Nnef, and the NEF sends the UE status information to the PCF through Nnef and Npcf. In this case, the AF is an untrusted AF.

In a third path, the AF sends the UE status information to the PCF through a TSCTSF. It can be understood that the AF can send the UE status information to the TSCTSF through Naf and Ntsctsf, and the TSCTSF sends the UE status information to the PCF through Ntsctsf and Npcf. In this case, the AF is a trusted AF, and the first service is a time sensitive service.

In a fourth path, the AF sends the UE status information to the PCF through a NEF and a TSCTSF. It can be understood that the AF can send the UE status information to the NEF through Naf and Nnef, and the NEF sends the UE status information to the TSCTSF through Nnef and Ntsctsf. Then the TSCTSF sends the UE status information to the PCF through Ntsctsf and Npcf. In this case, the AF is an untrusted AF, and the first service is a time sensitive service.

From the first to fourth manners mentioned above, it can be seen that for different types of AFs and/or types of the first service, one or more network functions (NFs), for example, the above NEF, the TSCTSF and the like, can be set between the AF and the PCF. Correspondingly, there may be different transmission paths for the UE status information. It should be noted that the above is only examples of the transmission paths for the UE status information and does not limit the transmission manner and the transmission path for the UE status information. The UE status information can also be transmitted from the AF to the PCF through other paths.

With the evolution of the communication system, there may be other deployment situations for the above NFs, which is not specifically limited in the embodiments of the present disclosure.

In some possible implementations, if the AF is an untrusted AF, the AF can provide the UE status information to the NEF, and the UE status information is carried in an AF request message. For example, the AF request message can include a NEF parameter create request message (for example, Nnef_ParameterProvision_Create Request), a NEF parameter update request message (for example, Nnef_ParameterProvision_Update Request), an AF session resource request message (for example, Nnef_AFsessionWithQos_Create request), etc. The NEF authorizes the request of the AF and executes a relevant mapping. Then, the NEF provides the UE status information to the PCF. In an embodiment, in a multi-UE scenario, the NEF can also provide UE status information to one or more PCFs corresponding to multiple UEs.

In an embodiment, the NEF may send the UE status information to the corresponding PCFs according to identifiers or a group identifier of the UEs.

In another embodiment, the PCF can subscribe to the NEF for an event associated with the UE status information. When the event satisfies a reporting condition, the PCF receives the UE status information reported by the NEF. Optionally, the NEF can also report service QoS update to the PCF.

In some possible implementations, after receiving the UE status information sent by the AF, the NEF can also send the UE status information to a user data repository (UDR) function entity or a unified data management (UDM) function entity, so as to store the UE status information as an AMF associated parameter, an SMF associated parameter, or a service characteristic parameter of application data.

In some possible implementations, the PCF can also receive alternative QoS profiles sent by the AF. Furthermore, the PCF can determine the one or more alternative QoS profiles to be sent to the access network function entity according to QoS policies.

In S302, the PCF sends the UE status information to the SMF or the AMF.

The UE status information is further configured for the access network function entity to determine a first QoS profile for one or more QoS flows associated with the UE from one or more alternative QoS profiles.

It can be understood that after receiving the UE status information of the UE, the PCF can provide it to the access network function entity through the SMF or the AMF.

As an example, the above S302 can be multiplexed with a service specific information provisioning procedure, a setting up an AF session with required QoS procedure, and the like. The above S302 can also be multiplexed in other procedures, which is not specifically limited in the embodiments of the present disclosure. For example, S302 can be a Nnef_XRMServiceParameter service, a Nnef_AFsessionWithQoS_Create request, etc.

Here, the one or more QoS flows associated with the UE can be related to the first service. In an embodiment of the present disclosure, the first service may be an XRM service or an XRM service group.

In some possible implementations, the above QoS flows may be of different granularities, for example, QoS flows for sessions (i.e., session QoS flows), QoS flows for services (e.g., service QoS flows), which is not specifically limited in the embodiments of the present disclosure.

It can be understood that the PCF can determine corresponding QoS parameters for one or more sessions of a service (i.e., the first service) of the UE according to the UE status information. Or, the PCF can determine the corresponding QoS parameters for a service (i.e., the first service) of the UE according to the UE status information. Here, “determine” can be described as “set,” “generate,” “update,” etc.

In S303, the PCF receives the first QoS profile from the SMF.

It can be understood that after receiving the first QoS profile sent by the access network function entity, the SMF can provide the first QoS profile to the PCF.

In some possible implementations, in S303, the PCF sends a subscription request message to the SMF, which is used to request a first event associated with the first QoS profile. If the first event satisfies an event reporting condition, the PCF receives the first QoS profile sent by the SMF.

It can be understood that the PCF can subscribe to the SMF for an event associated with the first QoS profile. After receiving the first QoS profile, the SMF queries subscription events and confirms the event associated with the first QoS profile. When the event satisfies the reporting condition, the SMF sends the first QoS profile to the PCF. The PCF can also obtain the first QoS profile from the SMF in other ways, which is not specifically limited in the embodiments of the present disclosure.

In S304, the PCF performs a QoS update based on the first QoS profile.

It can be understood that after receiving the first QoS profile determined according to the power consumption status of the UE, the PCF performs a QoS update on the one or more QoS flows associated with the UE by using the first QoS profile.

In S305, the PCF sends the first QoS profile to the AF for the AF to perform a QoS update.

In some possible implementations, the PCF can send the first QoS profile to the AF with reference to the first to fourth manners described above.

It should be noted that the above S304 and S305 can be executed simultaneously, or S304 can be executed first and then S305 is executed, which is not specifically limited in the embodiments of the present disclosure.

In some possible implementations, after S303, the PCF can also send the first QoS profile to other PCFs, which is used for other PCFs to perform a QoS update on the QoS flows.

It should be understood that in a multi-UE scenario, different UEs can correspond to different PCFs. So, when a PCF (which can be referred to as PCF 0) receives the first QoS profile from the access network function entity, it can provide the first QoS profile to other PCFs (for example, PCF 1, PCF 2, PCF 3, . . . ) for other PCFs to perform the QoS update process as described in S304 above.

As an example, the PCF 0 can directly send the first QoS profile to other PCFs such as the PCF 1, PCF 2, PCF 3 after receiving the first QoS profile. Or, other PCFs such as the PCF 1, PCF 2, PCF 3 can also subscribe to the PCF 0 for an event associated with the first QoS profile (i.e., the first event). When the first event satisfies a reporting condition, the PCF 0 sends the first QoS profile to other PCFs such as the PCF 1, PCF 2, PCF 3. Or, all PCFs subscribe to the NEF for the event associated with the first QoS profile. If the event satisfies the reporting condition, the NEF sends the first QoS profile to all PCFs. The multiple PCFs can also obtain the first QoS profile in other ways, which is not specifically limited in the embodiments of the present disclosure.

In some possible embodiments, the present disclosure also provides a QoS flow control method. FIG. 4 is a schematic diagram of an implementation procedure of a third QoS flow control method according to an embodiment of the present disclosure. As shown in FIG. 4, in this embodiment, the method is applied to a first core network function entity (for example, an SMF) side, and the method can include S401 to S404.

In S401, the SMF receives a first QoS profile sent by an access network function entity.

The first QoS profile is a QoS profile for one or more QoS flows associated with a UE determined by the access network function entity from one or more alternative QoS profiles according to UE status information of the UE.

It can be understood that, after determining the corresponding first QoS profile according to the UE status information provided by an AF, the access network function entity sends the first QoS profile to the SMF, and the SMF forwards it to the UE, a 5GC, and the AF.

In an embodiment, the access network function entity may send the first QoS profile to the SMF through a NAS message (for example, N2 SM information).

After S401, the SMF can perform at least one of S402 to S404.

In S402, the SMF performs a QoS update based on the first QoS profile.

In S403, the SMF sends the first QoS profile to a PCF, where the first QoS profile is configured for the PCF and/or the AF to perform a QoS update.

In S404, the SMF sends the first QoS profile to the UE, where the first QoS profile is configured for the UE to perform a QoS update.

In an embodiment of the present disclosure, the execution process of the SMF can refer to the description of the execution process of the SMF in the embodiments of FIGS. 2 to 4 above, and will not be repeated here for the sake of brevity.

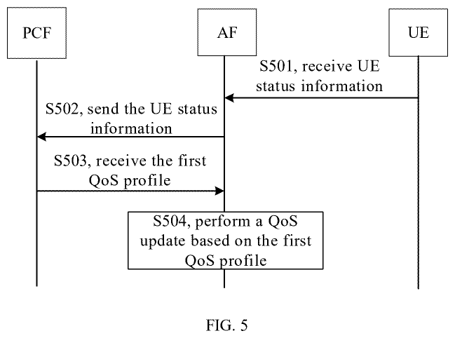

In some possible embodiments, the present disclosure also provides a QoS flow control method. FIG. 5 is a schematic diagram of an implementation procedure of a fourth QoS flow control method according to an embodiment of the present disclosure. As shown in FIG. 5, the method can be applied to an application function entity (for example, an AF) side, and the method can include S501 to S502.

In S501, the AF receives UE status information sent by a UE, where the UE status information is configured to represent a power consumption status of the UE.

It should be understood that after registering with the network, the UE selects a PCF to complete an access management (AM) session association. The UE sends the UE status information to the AF.

In S502, the AF sends the UE status information to the PCF, where the UE status information is further configured for an access network function entity to determine the above first QoS profile.

In some possible implementations, the AF can, and is not limited to, send the UE status information to the PCF through the following paths.

In a first path, the AF directly sends the UE status information to the PCF. It can be understood that the AF can send the UE status information to the PCF through Naf and Npcf. In this case, the AF is a trusted AF.

In a second path, the AF sends the UE status information to the PCF through a NEF. It can be understood that the AF can send the UE status information to the NEF through Naf and Nnef, and the NEF sends the UE status information to the PCF through Nnef and Npcf. In this case, the AF is an untrusted AF.

In a third path, the AF sends the UE status information to the PCF through a TSCTSF. It can be understood that the AF can send the UE status information to the TSCTSF through Naf and Ntsctsf, and the TSCTSF sends the UE status information to the PCF through Ntsctsf and Npcf. In this case, the AF is a trusted AF, and the first service is a time sensitive service.

In a fourth path, the AF sends the UE status information to the PCF through a NEF and a TSCTSF. It can be understood that the AF can send the UE status information to the NEF through Naf and Nnef, and the NEF sends the UE status information to the TSCTSF through Nnef and Ntsctsf. Then the TSCTSF sends the UE status information to the PCF through Ntsctsf and Npcf. In this case, the AF is an untrusted AF, and the first service is a time sensitive service.

From the first to fourth manners mentioned above, it can be seen that for different types of AFs and/or types of the UE service, one or more network functions (NFs), for example, the above NEF, the TSCTSF and the like, can be set between the AF and the PCF. Correspondingly, there may be different transmission paths for the UE status information. It should be noted that the above is only examples of the transmission paths for the UE status information and does not limit the transmission manner and the transmission path for the UE status information. The UE status information can also be transmitted from the AF to the PCF through other paths.

With the evolution of the communication system, there may be other deployment situations for the above NFs, which is not specifically limited in the embodiments of the present disclosure.

In some possible implementations, if the AF is an untrusted AF, the AF can provide the UE status information to the NEF, and the UE status information is carried in an AF request message. For example, the AF request message can include a NEF parameter create request message (for example, Nnef_ParameterProvision_Create Request), a NEF parameter update request message (for example, Nnef_ParameterProvision_Update Request), an AF session resource request message (for example, Nnef_AFsessionWithQos_Create request), etc. The NEF authorizes the request of the AF and executes a relevant mapping. Then, the NEF provides the UE status information to the PCF. In an embodiment, in a multi-UE scenario, the NEF can also provide UE status information to one or more PCFs corresponding to multiple UEs.

In an embodiment, the NEF may send the UE status information to the corresponding PCFs according to identifiers or a group identifier of the UEs.

In another embodiment, the PCF can subscribe to the NEF for an event associated with the UE status information. When the event satisfies a reporting condition, the PCF receives the UE status information reported by the NEF. Optionally, the NEF can also report service QoS update to the PCF.

In some possible implementations, after receiving the UE status information sent by the AF, the NEF can also send the UE status information to a UDR or a UDM, so as to store the UE status information as an AMF associated parameter, an SMF associated parameter, or a service characteristic parameter of application data.

In S503, the AF receives the first QoS profile sent by the PCF.

In some possible implementations, in S503, the AF sends a subscription request message to the PCF, which is used to request a first event associated with the first QoS profile. If the first event satisfies an event reporting condition, the AF receives the first QoS profile sent by the PCF.

In S504, the AF performs a QoS update based on the first QoS profile.

In the embodiment of the present disclosure, the execution process of the AF can refer to the description of the execution process of the AF in the embodiments of FIGS. 2 to 4 above, and will not be repeated here for the sake of brevity.

Thus, the QoS control process for QoS flows is implemented.

In the embodiment of the present disclosure, the UE status information of the UE is provided to the access network function entity through the AF entity, so that the access network function entity can match service traffic characteristics and terminal energy consumption management according to the UE status information, that is, select the corresponding QoS profile according to the power consumption status of the terminal, so as to ensure service requirements and user experience. Furthermore, the UE status information provided by the AF as additional information for policy determination can reduce the use of wireless interface network resources, especially in situations where resources are limited. Further, the UE status information of the UE is provided to the access network function entity through the AF entity, which can support the use of network resources according to capabilities of the terminal. Further, the UE status information of the UE is provided to the access network function entity through the AF entity, so that the user's critical application programs are allowed to run in the power saving mode, thereby improving the user experience and prolonging the battery life, instead of completely shutting down.

In order to better understand the embodiments of the present disclosure, further explanation can be made through, but not limited to, the following exemplary process.

### Example 1

In this example, an AF can transmit UE status information to a PCF through a service specific information provisioning procedure, and then the PCF can transmit the UE status information to a RAN through an AMF.

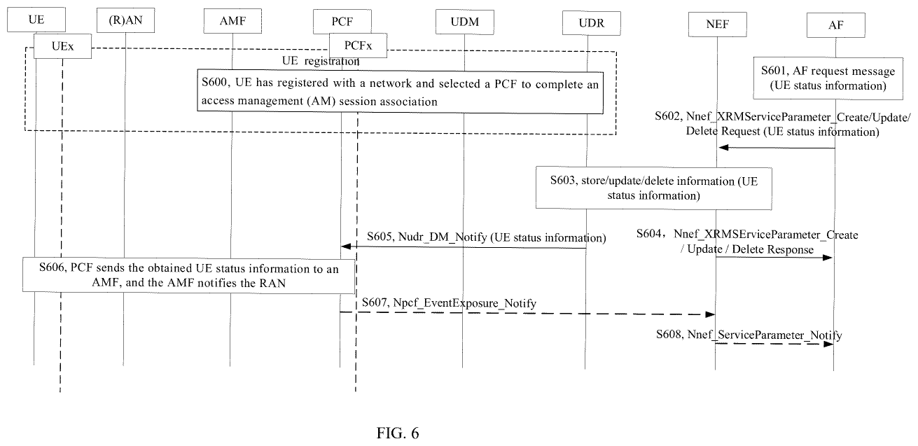

FIG. 6 is a schematic diagram of a service specific information provisioning procedure according to an embodiment of the present disclosure. Referring to FIG. 6, the above process may include S600 to S608.

In S600, the UE has registered with a network and selected a PCF to complete an access and mobility management (AM) session association.

According to subscription information or service policies (for example, QoS requirements) of UE or a first service (for example, an XRM service or multimodal data service), the PCF subscribes to a UDM for at least one of the following notifications: a change notification of the UE status information, a change notification of policies related to the first service, or a change notification of subscription information of the first service. Optionally, if the first service (XRM service or XRM service group) is associated with multiple PCFs (for example, PFCx), these PCFs all subscribe to the UDM.

In S601, the AF triggers a Nnef_XRMServiceParameter service, creates an AF request message which includes the UE status information.

Optionally, the AF request message may also include an XRM service identifier or an XRM service group identifier. The AF provides specific parameters of the first service (for example, XRM service or multiple data service specific parameters) to a single UE or multiple UEs related to the above service through the Nnef_XRMServiceParameter service. The information sent by the AF includes Service Description, Service Parameters, UE/Group UE, and Subscription to events. Specifically:

1. Service Description, which identifies the XRM service or an XRM data service; the XRM service or the XRM data service can be identified by a combination of a data network name (DNN) and network slice selection assistance information (S-NSSAI), or by an XRM service identifier (XRM ID), or can be represented by an AF-Service-Identifier or an external Application identifier (server identifier).

2. Service Parameters, information on the AF guidance for the XRM service or multimodal data service related policy and QoS determination. For example, the Service Parameters include at least one of the following: a list of rules that associate the XRM service or multiple data service application traffic, UE policy and other parameters, a service group identifier (group ID), or a combination of DNN and S-NSSAI, a session and service continuity (SSC) mode, alternative QoS parameters and priorities, and selection priorities for corresponding rules (for example, corresponding location or time window priorities, corresponding access type or routing selection priorities, etc.).

3. A single UE or multiple UEs (Group UE) related to the XRM service or multiple data service associated with the AF request message.

4. Subscription to events, the AF may subscribe to notifications about the execution or change of the outcome of the session management (SM) policy, AM policy, or UE policy.

When the AF needs to update and delete corresponding request or subscription, the update and deletion process of the AF request can also be initiated through this service.

In S602, the AF sends the request message (a Nnef_XRMServiceParameter_Create/Update/Delete Request) to a NEF.

Here, the NEF authorizes the AF request message. The NEF executes a relevant mapping, including a mapping from external to a core network (CN) identifier. The message carries the UE status information and/or alternative QoS profiles (for example, alternative QoS parameters and priorities).

The NEF stores the UE status information and/or the alternative QoS parameters and priorities to a UDR/UDM, which can be stored as an AMF associated parameter, an SMF associated parameter, or a service characteristic parameter of application data.

Optionally, the NEF may refine corresponding service parameters according to local configuration. Optionally, based on operator policies, the NEF can combine subscription information to confirm whether to request authorization for service characteristics for the XRM service or multimodal data service of a single UE or multiple UEs in a group and store the corresponding parameters in the UDR.

If multiple UEs are involved, the NEF may transmit the UE status information and/or alternative QoS parameters and priorities, and/or relevant service parameters to the PCFs. Corresponding authorization, as well as policy and rule decisions or updates are performed in each PCF, and make decisions or updates of policies and rules. The PCF stores corresponding information to the UDR according to an authorization result of the request (The NEF can directly send the UE status information and/or alternative QoS parameters and priorities, and/or relevant service parameters to a group-related PCF according to the group identifier, or store them in the UDM and then send them to the group-related PCF through a subscription report).

Optionally, for a multi-UE scenario, subscription data of UE group members is associated through an XRM service indication or group ID, where group data of group UEs remains consistent (for example, QoS of services, access and characteristic parameters of data routing).

Further, the PCF can subscribe to related XRM service or multimodal data related event trigger through the NEF, for example, UE status information, service QoS update, UE relocation, PCF change, etc.

Then, the PCF obtains the corresponding UE status information by receiving a NEF report. Optionally, collaboration of policies such as QoS update is performed (For example, in XRM service or multimodal data group, if QoS characteristic parameters of UE1 change, an event report is triggered to the NEF, and forwarded to corresponding other UEs in the XRM service or multimodal data group, or a PCF associated with other application traffic of the same UE, to perform the corresponding session update).

In S604, the NEF returns a create request response message (Nnef_XRMSErviceParameter_Create/Update/Delete Response) to the AF.

In S605, the PCF receives a subscription information change notification from a UDR/UDM.

In S606, the PCF sends the obtained UE status information to an AMF, and the AMF notifies the RAN, so that the (R)AN can determine a first QoS profile for one or more QoS flows associated with the UE from one or more alternative QoS profiles according to the UE status information.

In S607, if the AF subscribes to an execution notification of XRM service-related policies, the PCF sends a related execution result to the AF through the NEF (Npcf_EventExposure_Notify). At the same time, if there is a UE status information subscription or related subscription parameter change subscription, the PCF will update the change to the UDR, triggering the serving PCF of UEs related to the XRM service group to perform policy change and collaboration. Here, if in a multi-PCF scenario, other PCFs can be directly triggered for the PCF to perform a QoS change; or, after storing UE status information/XRM service group policies in the UDM, the PCF triggers the subscription of UDM/NEF UE status information and reports it to corresponding PCFs, and UE status information retrieval of relevant one or more PCFs or a direct change of the XRM service group policies is performed.

In S608, after receiving the notification, the NEF first performs mapping of internal and external related parameters, and then reports the relevant status to the AF (Nnef_ServiceParameter_Notify).

For the above, it should be noted that the steps in this example are only illustrative, and other steps can refer to the service specific information provisioning procedure in related technologies.

It should be noted that those skilled in the art can understand that the method provided in the embodiment of the present disclosure can be executed alone or together with some methods in the embodiments of the present disclosure or some methods in related technologies.

### Example 2

In this example, an AF can transmit UE status information to a PCF through a setting up an AF session with required QoS procedure, and then the PCF can transmit the UE status information to a RAN through an SMF.

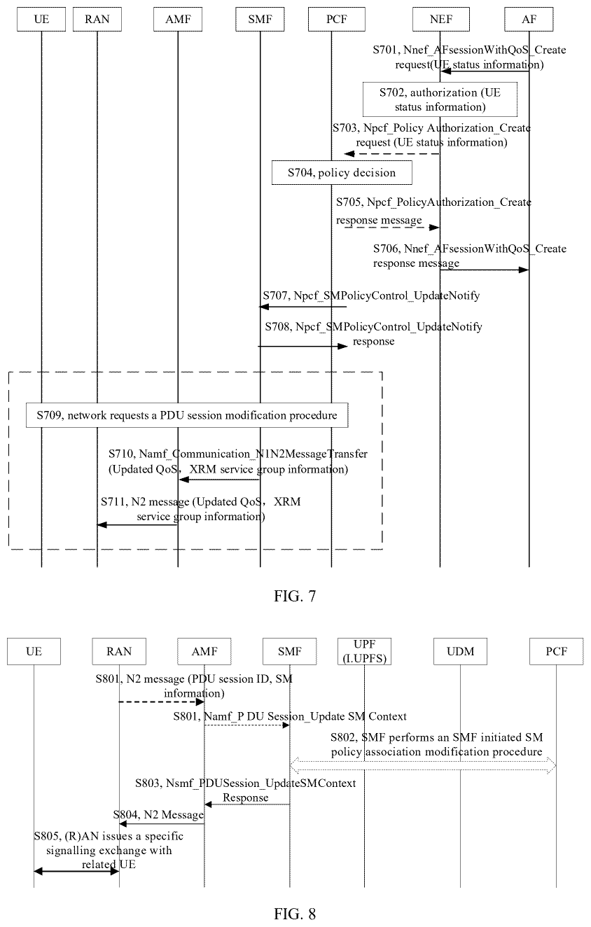

FIG. 7 is a schematic diagram of a setting up an AF session with required QoS procedure according to an embodiment of the present disclosure. Referring to FIG. 7, the above process may include S700 to S711.

Firstly, the AF sends an AF session resource request. For example, an AF request message is created through Nnef_AFsessionWithQoS_Create request. The AF carries the UE status information in the request message.

Optionally, the above request message may also include at least one of the following: alternative QoS, XRM service group information, UE address/UE identifier, AF identifier application ID, QoS flow description(s), DNN, S-NSSAI, QoS parameters, and other information. Here, a group ID can be used to identify all flows in the XRM service group.

In S701, the AF sends the request message to a NEF (Nnef_AFsessionWithQoS_Create request), which carries the UE status information. Optionally, the request message also carries alternative QoSs. The NEF authorizes the AF request and performs a relevant mapping, including a mapping from external to a CN identifier.

In S702, the NEF authorizes the AF request and determines whether to invoke a TSCTSF or directly send the AF request to the PCF according to parameters provided by the AF. The PCF can receive information provided by the AF from the NEF or the TSCTSF. The NEF triggers Npcf_PolicyAuthorization_Create request and sends the authorized AF request to the PCF, carrying the UE status information. Optionally, the AF request can also carry alternative QoSs (for PCF policy decision) and XRM service group information. The NEF triggers a session update for corresponding data flows of the XRM service group according to the execution in S701.

In S703, the NEF stores the request information to a UDR/UDM (Npcf_Policy Authorization_Create request (UE status information)). The NEF stores the UE status information to the UDR/UDM, which can be stored as an AMF associated parameter, an SMF associated parameter, or a service characteristic parameter of application data.

If multiple UEs are involved, the NEF can transmit the UE status information and/or relevant service parameters to the PCF. Corresponding authorization, as well as policy and rule decisions or updates are performed in each PCF. The PCF stores corresponding information to the UDR according to an authorization result of the request (The NEF can directly send the UE status information and/or relevant service parameters to a group-related PCF according to the group identifier (group ID), or store them in the UDM and then send them to the group-related PCF through a subscription report).

Optionally, for a multi-UE scenario, subscription data of UE group members is associated through an XRM service indication or group ID, where group data of group UEs remains consistent (for example, QoS of services, access and characteristic parameters of data routing).

In an embodiment, the PCF can subscribe to events related to XRM service or multimodal data through the NEF, for example, UE status information, service QoS update, UE relocation, PCF change, etc.

Further, the PCF obtains the corresponding UE status information by receiving the report from the NEF. Optionally, the PCF performs collaboration of subsequent QoS update and other policies (For example, in XRM service or multimodal data group, if QoS characteristic parameters of UE1 change, an event report is triggered to the NEF, and forwarded to corresponding other UEs in the XRM service or multimodal data group, or a PCF associated with other application traffic of the same UE, to perform the corresponding session update).

In S704, the PCF makes a policy decision. The PCF may determine whether updated or new policy information needs to be sent to the SMF.

The PCF generates or updates policy control and charging (PCC) rules based on the UE status information provided by the NEF. The PCF triggers Npcf_SMPolicyControl_UpdateNotify to update policy information about the corresponding PDU session of the SMF, including PCC rules and QoS policies related to the AF request.

In S705, the PCF sends a Npcf_PolicyAuthorization_Create response message to the NEF.

In S706, the NEF sends a Nnef_AFsessionWithQoS_Create response message to the AF, carrying the QoS profiles mentioned above, to inform whether the request is authorized.

In S707, the PCF triggers a Npcf_SMPolicyControl_UpdateNotify operation based on possibly updated policy information about the PDU session of the SMF. This update includes information provided by the AF in S701 and mapped by the PCF to a specific PDU session. The PCF will send the obtained UE status information to the SMF.

In S708, the SMF acknowledges the PCF request with a Npcf_SMPolicyControl_UpdateNotify response.

In S709-S711, the SMF triggers a PDU session modification procedure, so that the (R)AN can determine a QoS profile for one or more QoS flows associated with the UE from one or more alternative QoS profiles according to the UE status information.

For the above, it should be noted that the steps in this example are only illustrative, and other steps can refer to the setting up an AF session with required QoS procedure in related technologies.

It should be noted that those skilled in the art can understand that the method provided in the embodiment of the present disclosure can be executed alone or together with some methods in the embodiments of the present disclosure or some methods in related technologies.

### Example 3

In this example, a RAN can transmit a first QoS profile to a UE, a 5GC, and an AF through a PDU session modification procedure.

FIG. 8 is a schematic diagram of a PDU session modification procedure according to an embodiment of the present disclosure. Referring to FIG. 8, the above process may include S801 to S805.

In S801, (AN initiated notification control) If notification control is configured for a GBR QoS flow, the (R)AN sends a N2 message (PDU session ID, N2 SM information) to the SMF when the (R)AN decides QoS targets of the QoS flow cannot be fulfilled or can be fulfilled again, respectively. The N2 SM information includes a QoS Flow Identity (QFI) and an indication that the QoS targets for that QoS flow cannot be fulfilled or can be fulfilled again, respectively. When the QoS targets cannot be fulfilled, the N2 SM information indicates a reference to the alternative QoS profile matching values of QoS parameters that the NG-RAN is currently fulfilling (optionally, and the corresponding UE status). The AMF invokes Nsmf_PDUSession_UpdateSMContext (SM context ID, N2 SM information). If the PCF has subscribed to the event, the SMF reports this event to the PCF for each PCC rule for which notification control is set.

In S802, the SMF may need to report some subscribed events to the PCF by performing an SMF initiated SM policy association modification procedure. If a dynamic PCC is not deployed, the SMF may apply a local policy to decide whether to change the QoS profile.

In S803, for AN initiated modification, the SMF responds to the AMF through Nsmf_PDUSession_UpdateSMContext Response ([N2 SM information (PDU session ID, QFI(s), QoS Profile(s), [alternative QoS profile(s)], Session-AMBR], [CN Tunnel Info(s)]), N1 SM container (PDU session modification command (PDU session ID, QoS rule(s), QoS rule operation, QoS flow level QoS parameters if needed for the QoS flow(s) associated with the QoS rule(s), Session-AMBR, [Always-on PDU Session Granted], [Port Management Information Container], [corresponding UE status]))). It should be noted that alternative QoS profile is only valid for AN initiated modification.

The N2 SM information carries information that the AMF shall provide to the (R)AN. It may include the QoS profiles and the corresponding QFIs to notify the (R)AN that one or more QoS flows were added, or modified, and may include the corresponding UE status.

The N1 SM container carries the PDU session modification command that the AMF shall provide to the UE. It may include the QoS rules, QoS flow level QoS parameters (if needed) for the QoS flow(s) associated with the QoS rule(s) and corresponding QoS rule operation and QoS flow level QoS parameters operation to notify the UE that one or more QoS rules were added, removed or modified. It may include the corresponding UE status. The SMF may need to send transparently through the RAN the PDU session modification command to inform the UE, about changes in QoS parameters (i.e., 5QI, GFBR, MFBR) that the RAN is currently fulfilling after the SMF receives QoS notification control. When the SMF sends on the PDU session modification command transparently through the RAN, the N2 SM information is not included as part of the Namf_Communication_N1N2MessageTransfer.

In S804, the AMF may send N2 ([N2 SM information received from SMF], NAS message (PDU session ID, N1 SM container (PDU session modification command))) message to the (R)AN.

In S805, the (R)AN may issue a specific signalling exchange with the UE that is related with the information received from the SMF. For example, in the case of a NG-RAN, an RRC connection reconfiguration may take place with the UE modifying the necessary (R)AN resources related to the PDU session or if only the N1 SM container is received in step S804 from the AMF, the RAN transports only the N1 SM container to the UE.

For the above, it should be noted that the steps in this example are only for illustrative, and other steps can refer to the PDU session modification procedure in related technologies.

It should be noted that those skilled in the art can understand that the method provided in the embodiment of the present disclosure can be executed alone or together with some methods in the embodiments of the present disclosure or some methods in related technologies.

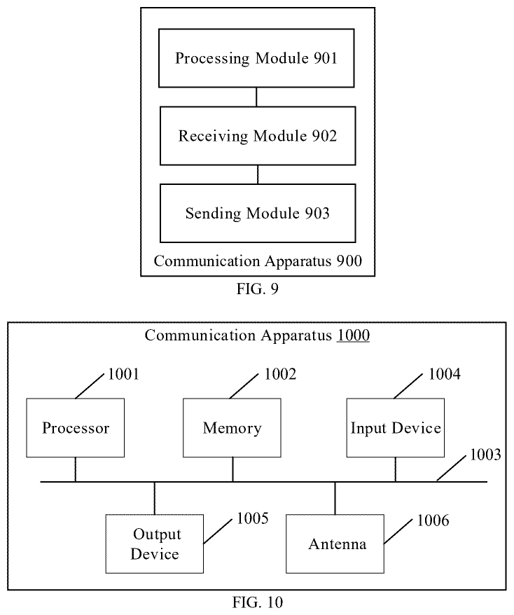

Based on the same inventive concept, an embodiment of the present disclosure provides a communication apparatus. FIG. 9 is a schematic structural diagram of a communication apparatus according to an embodiment of the present disclosure. Referring to FIG. 9, a communication apparatus 900 can include a processing module 901, a receiving module 902, and a sending module 903.

In some possible embodiments, the communication apparatus 900 may be an access network function entity or a chip or a system on chip (SoC) of the access network function entity in a communication system, or a function module for implementing the methods described in the above embodiments in the access network function entity. The communication apparatus 900 can implement the functions performed by the access network function entity in the above embodiments, which can be implemented by hardware executing corresponding software. These hardware or software includes one or more modules corresponding to the above functions.

Correspondingly, the receiving module 902 is configured to receive terminal status information from an application function (AF) entity, where the terminal status information is configured to represent a power consumption status of a terminal. The processing module 901 is configured to determine a first QoS profile for one or more QoS flows associated with the terminal from one or more alternative QoS profiles according to the terminal status information. The sending module 903 is configured to send the first QoS profile by the access network function entity to a first core network function entity, where the first QoS profile is configured for at least one of the terminal, the first core network function entity, a second core network function entity, or the AF entity to perform a QoS update.

In some possible implementations, the terminal status information includes at least one of: a battery level; a battery life; a powered mode; a central processing unit (CPU) load; or a terminal overheating status.

In some possible implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some possible implementations, the processing module 901 is configured to determine the first QoS profile according to the terminal status information and the terminal status management indication in the one or more alternative QoS profiles.

In some possible implementations, the processing module 901 is configured to determine the first QoS profile according to the terminal status information and an association relationship between terminal status information and QoS profiles.

In some possible implementations, the receiving module 902 is configured to receive the association relationship sent by the second core network function entity; or, the processing module 901 is configured to configure the association relationship according to a local policy and/or an operator policy.

In some possible implementations, the receiving module 902 is configured to receive the one or more alternative QoS profiles sent by the second core network function entity.

In some possible implementations, the receiving module 902 is configured to receive the terminal status information from the second core network function entity, where the terminal status information is sent to the second core network function entity by the AF entity.

In some possible implementations, the sending module 903 is configured to send a non access stratum (NAS) message to the first core network function entity, where the NAS message carries the first QoS profile.

In some possible embodiments, the communication apparatus 900 may be a second core network function entity or a chip or a SoC of the second core network function entity in a communication system, or a function module for implementing the methods described in the above embodiments in the second core network function entity. The communication apparatus 900 can implement the functions performed by the second core network function entity in the above embodiments, which can be implemented by hardware executing corresponding software. These hardware or software includes one or more modules corresponding to the above functions.

Correspondingly, the communication apparatus 900 can include: a receiving module 902 configured to receive terminal status information from an application function (AF) entity, where the terminal status information is configured to represent a power consumption status of a terminal; and a sending module 903 configured to send the terminal status information to a first core network function entity or a third core network function entity, where the terminal status information is further configured for an access network function entity to determine a first QoS profile for one or more QoS flows associated with the terminal from one or more alternative QoS profiles.

In some possible implementations, the terminal status information includes at least one of: a battery level; a battery life; a powered mode; a central processing unit (CPU) load; or a terminal overheating status.

In some possible implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some possible implementations, the AF entity is a trusted AF entity, where the receiving module 902 is configured to one of: receive the terminal status information sent by the AF entity; receive the terminal status information sent by a time sensitive communication and time synchronization function (TSCTSF) entity, where the terminal status information is sent to the TSCTSF entity by the AF entity.

In some possible implementations, the AF entity is an untrusted AF entity, where the receiving module 902 is configured to one of: receive the terminal status information sent by a network exposure function (NEF) entity, where the terminal status information is sent to the NEF entity by the AF entity; receive the terminal status information sent by a time sensitive communication and time synchronization function (TSCTSF) entity, where the terminal status information is sent to the TSCTSF entity by the AF entity through the NEF entity.

In some possible implementations, the receiving module 902 is configured to receive the first QoS profile sent by the first core network function entity, where the first QoS profile is sent by the access network function entity to the first core network function entity.

In some possible implementations, the sending module 903 is configured to send a subscription request message to the first core network function entity, where the subscription request message is configured to request a first event associated with the first QoS profile; where the receiving module 902 is configured to receive the first QoS profile sent by the first core network function entity if the first event satisfies an event reporting condition.

In some possible implementations, the sending module 903 is configured to send the first QoS profile to a fourth core network function entity, where the first QoS profile is configured for the fourth core network function entity to perform a QoS update.

In some possible implementations, the sending module 903 is configured to send the first QoS profile to the AF entity, where the first QoS profile is configured for the AF entity to perform a QoS update.

In some possible implementations, the receiving module 902 is configured to receive the one or more alternative QoS profiles sent by the AF entity.

In some possible embodiments, the communication apparatus 900 may be a first core network function entity or a chip or a SoC of the first core network function entity in a communication system, or a function module for implementing the methods described in the above embodiments in the first core network function entity. The communication apparatus 900 can implement the functions performed by the first core network function entity in the above embodiments, which can be implemented by hardware executing corresponding software. These hardware or software includes one or more modules corresponding to the above functions.

Correspondingly, the receiving module 902 is configured to receive a first QoS profile sent by an access network function entity, where the first QoS profile is a QoS profile for one or more QoS flows associated with a terminal determined by the access network function entity from one or more alternative QoS profiles according to terminal status information of the terminal. The communication apparatus 900 also includes at least one of the following: a processing module 901 configured to perform a QoS update on the one or more QoS flows associated with the terminal according to the first QoS profile; or a sending module 903 configured to send the first QoS profile to a second core network function entity, where the first QoS profile is configured for the second core network function entity and/or an application function (AF) entity to perform a QoS update; or send the first QoS profile to the terminal, where the first QoS profile is configured for the terminal to perform a QoS update.

In some possible implementations, the terminal status information includes at least one of: a battery level; a battery life; a powered mode; a central processing unit (CPU) load; or a terminal overheating status.

In some possible implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some possible implementations, the processing module 901 is configured to query subscription events to determine a first event associated with the first QoS profile; and the sending module 903 is configured to send the first QoS profile to the second core network function entity if the first event satisfies an event reporting condition.

In some possible implementations, the sending module 903 is configured to send a non access stratum (NAS) message to the terminal, where the NAS message carries the first QoS profile.

In some possible embodiments, the communication apparatus 900 may be an application function (AF) entity or a chip or a SoC of the AF entity in a communication system, or a function module for implementing the methods described in the above embodiments in the AF entity. The communication apparatus 900 can implement the functions performed by the AF entity in the above embodiments, which can be implemented by hardware executing corresponding software. These hardware or software includes one or more modules corresponding to the above functions.

Correspondingly, the receiving module 902 is configured to receive terminal status information sent by a terminal, where the terminal status information is configured to represent a power consumption status of the terminal; the sending module 903 is configured to send the terminal status information to a second core network function entity, where the terminal status information is further configured for an access network function entity to determine a first QoS profile for one or more QoS flows associated with the terminal from one or more alternative QoS profiles according to the terminal status information of the terminal.

In some possible implementations, the terminal status information includes at least one of: a battery level; a battery life; a powered mode; a central processing unit (CPU) load; or a terminal overheating status.

In some possible implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some possible implementations, the AF entity is a trusted AF entity, where the sending module 903 is configured to one of: send the terminal status information to the second core network function entity; send the terminal status information to a time sensitive communication and time synchronization function (TSCTSF) entity, where the terminal status information is further configured for the TSCTSF entity to send to the second core network function entity.

In some possible implementations, the AF entity is an untrusted AF entity, where the sending module 903 is configured to send the terminal status information to a network exposure function (NEF) entity, where the terminal status information is further configured for the NEF entity to send to the second core network function entity through a time sensitive communication and time synchronization function (TSCTSF) entity.

In some possible implementations, the receiving module 902 is configured to receive the first QoS profile sent by the second core network function entity; and the processing module is configured to perform a QoS update on the one or more QoS flows associated with the terminal according to the first QoS profile.

It should be noted that the specific implementation processes of the processing module 901, the receiving module 902, and the sending module 903 can refer to the detailed descriptions of the embodiments in FIGS. 2 to 5, and are not repeated here for the sake of brevity.

The receiving module 902 mentioned in the embodiments of the present disclosure can be a receiving interface, a receiving circuit, or a receiver, etc. The sending module 903 can be a sending interface, a sending circuit, or a transmitter, etc. The processing module 901 can be one or more processors.

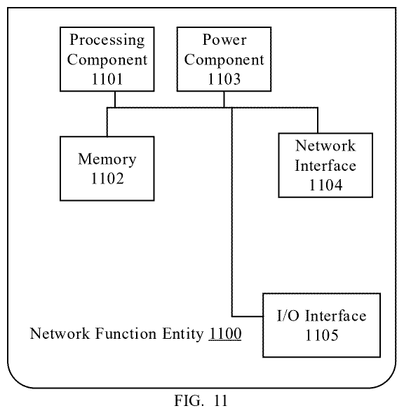

Based on the same inventive concept, an embodiment of the present disclosure provides a communication apparatus, which can be the access network function entity, the first core network function entity, the second core network function entity, or the application function entity as described in one or more of the above embodiments. FIG. 10 is a schematic structural diagram of a communication apparatus in an embodiment of the present disclosure. Referring to FIG. 10, the communication apparatus 1000 adopts general computer hardware, including a processor 1001, a memory 1002, a bus 1003, an input device 1004, and an output device 1005.

In some possible implementations, the memory 1002 can include computer storage media in the form of volatile and/or non-volatile memory, such as read-only memory and/or random access memory. The memory 1002 can store operating systems, application programs, other program modules, executable codes, program data, user data, etc.

The input device 1004 may be used to input instructions and information to the communication apparatus. The input device 1004 may be a keyboard or a pointing device, such as a mouse, a trackballs, a touchpad, a microphone, a joystick, a game pad, a satellite television antenna, a scanner, or other devices. These input devices may be connected to the processor 1001 via the bus 1003.

The output device 1005 may be used for the communication apparatus to output information. In addition to a monitor, the output device 1005 may be other peripheral output devices, such as speakers and/or printing devices, which may also be connected to the processor 1001 via the bus 1003.

The communication apparatus may be connected to the network, such as a local area network (LAN), via an antenna 1006. In a networked environment, computer executable instructions stored in a control device may be stored in a remote storage device, which is not limited to local storage.

When the processor 1001 in the communication apparatus executes the executable codes or application programs stored in the memory 1002, the communication apparatus executes the QoS flow control method or on the network device side in the above embodiments, and the specific execution process is described with reference to the above embodiments, and will not be repeated herein.

In addition, the above memory 1002 stores computer executable instructions for implementing the functions of the processing module 901, the receiving module 902, and the sending module 903 in FIG. 9. The functions/implementation processes of the processing module 901, the receiving module 902, and the sending module 903 in FIG. 9 can all be achieved by the processor 1001 in FIG. 10 calling the computer executable instructions stored in the memory 1002. The specific implementation process and functions refer to the relevant embodiments mentioned above.

Based on the same inventive concept, an embodiment of the present disclosure provides a network function entity, such as an access network function entity, a first core network function entity, a second core network function entity, or an application function entity.

FIG. 11 is a schematic structural diagram of a network function entity according to an embodiment of the present disclosure. Referring to FIG. 11, the network function entity 1100 may include a processing component 1101, which further includes one or more processors, and memory resources represented by a memory 1102, for storing instructions that can be executed by the processing component 1101, such as an application program. The application program stored in memory 1102 may include one or more modules each corresponding to a set of instructions. In addition, the processing component 1101 is configured to execute the instructions to perform any one of the aforementioned methods applied to the network device.

The network function entity 1100 may also include a power component 1103 configured to perform power management for the network function entity 1100, a wired or wireless network interface 1104 configured to connect the network function entity 1100 to a network, and an input/output (I/O) interface 1105. The network function entity 1100 can operate based on an operating system stored in the memory 1102, such as Windows Server TM, Mac OS XTM, UnixTM, LinuxTM, FreeBSDTM, or the like.

Based on the same inventive concept, an embodiment of the present disclosure also provides a communication apparatus, for example, an access network function entity, a first core network function entity, a second core network function entity, or an application function entity, including a memory and a processor. The processor is connected to the memory and configured to execute computer executable instructions stored on the memory to implement the method described in one or more of the above embodiments.

Based on the same inventive concept, an embodiment of the present disclosure also provides a computer readable storage medium, in which instructions are stored. When executed on a computer, the instructions are used to execute the QoS flow control method on the network function entity side in one or more of the above embodiments. Here, the network function entity may include the access network function entity, the first core network function entity, the second core network function entity, and the application function entity.

Based on the same inventive concept, an embodiment of the present disclosure also provide a computer program or computer program product that, when executed on a computer, causes the computer to implement the QoS flow control method on the network function entity side in one or more of the above embodiments. Here, the network function entity may include the access network function entity, the first core network function entity, the second core network function entity, and the application function entity.

Those skilled in the art will readily contemplate other embodiments of the present disclosure upon consideration of the specification and practice of the present disclosure disclosed herein. The present disclosure is intended to cover any variations, uses, or adaptions of the present disclosure that conform to the general principles of the present disclosure and include common knowledge or conventional technical means in the technical field which are not disclosed in the present disclosure. It is intended that the description and embodiments shall be considered as illustrative only, and the true scope and spirit of the present disclosure are indicated by the appended claims.

It should be understood that the present disclosure is not limited to the precise structures that have been described above and shown in the accompanying drawings, and various modifications and changes can be made without departing from the scope thereof. The scope of the present disclosure is defined only by the appended claims.

1. A method for quality of service (QoS) flow control performed by an access network function, the method comprising:
receiving terminal status information from an application function (AF), wherein the terminal status information is configured to represent a power consumption status of a terminal;
determining a first QoS profile for one or more QoS flows associated with the terminal from one or more alternative QoS profiles according to the terminal status information; and
sending the first QoS profile to a first core network function, wherein the first QoS profile is configured for at least one of the terminal, the first core network function, a second core network function, or the AF to perform a QoS update.

2. The method according to claim 1, wherein the method comprises at least one of:
the first core network function comprises a session management function (SMF), and the second core network function comprises a policy control function (PCF);
the terminal status information comprises at least one of: a battery level; a battery life; a powered mode; a central processing unit (CPU) load; or a terminal overheating status;
or,
the one or more alternative QoS profiles comprise at least one of: a packet delay budget; a packet error rate; an uplink guaranteed bitrate; a downlink guaranteed bitrate; an averaging window; a maximum data burst volume; or a terminal status management indication, configured to indicate whether the one or more alternative QoS profiles support application to terminal status management.

3-4. (canceled)

5. The method according to claim 1, wherein determining the first QoS profile for the one or more QoS flows associated with the terminal from the one or more alternative QoS profiles according to the terminal status information comprises at least one of:
determining the first QoS profile according to the terminal status information and the terminal status management indication in the one or more alternative QoS profiles; or
determining the first QoS profile according to the terminal status information and an association relationship between terminal status information and QoS profiles.

6. (canceled)

7. The method according to claim 5, further comprising:
receiving the association relationship sent by the second core network function; or,
configuring the association relationship according to a local policy and/or an operator policy.

8. The method according to claim 1, further comprising:
receiving the one or more alternative QoS profiles sent by the second core network function.

9. The method according to claim 1, wherein the method comprises at least one of:
receiving the terminal status information from the AF comprises:
receiving the terminal status information from the second core network function, wherein the terminal status information is sent to the second core network function by the AF; or
sending the first QoS profile to the first core network function comprises: sending a non access stratum (NAS) message to the first core network function, wherein the NAS message carries the first QoS profile.

10. (canceled)

11. A method for quality of service (QoS) flow control performed by a second core network function, the method comprising:
receiving terminal status information from an application function (AF), wherein the terminal status information is configured to represent a power consumption status of a terminal; and
sending the terminal status information to an access network function, wherein the terminal status information is further configured for the access network function to determine a first QoS profile for one or more QoS flows associated with the terminal from one or more alternative QoS profiles.

12-14. (canceled)

15. The method according to claim 11, wherein the AF is a trusted AF, wherein receiving the terminal status information from the AF comprises one of:
receiving the terminal status information sent by the AF;
receiving the terminal status information sent by a time sensitive communication and time synchronization function (TSCTSF), wherein the terminal status information is sent to the TSCTSF by the AF;
or,
wherein the AF is an untrusted AF, wherein receiving the terminal status information from the AF comprises one of:
receiving the terminal status information sent by a network exposure function (NEF), wherein the terminal status information is sent to the NEF by the AF;
receiving the terminal status information sent by the time sensitive communication and time synchronization function (TSCTSF), wherein the terminal status information is sent to the TSCTSF by the AF through the NEF.

16. (canceled)

17. The method according to claim 11, wherein the method further comprises at least one of:
sending the terminal status information to the access network function comprises: sending the terminal status information to the access network function through a first core network function or a third core network function;
or,
receiving the one or more alternative QoS profiles sent by the AF.

18. The method according to claim 11, further comprising:
receiving the first QoS profile sent by a first core network function.

19. The method according to claim 18, wherein the method further comprises at least one of:
receiving the first QoS profile sent by the first core network function comprises:
sending a subscription request message to the first core network function, wherein the subscription request message is configured to request a first event associated with the first QoS profile; and
receiving the first QoS profile sent by the first core network function if the first event satisfies an event reporting condition;
sending the first QoS profile to a fourth core network function, wherein the first QoS profile is configured for the fourth core network function to perform a QoS update;
or,
sending the first QoS profile to the AF, wherein the first QoS profile is configured for the AF to perform a QoS update.

20-22. (canceled)

23. A method for quality of service (QoS) flow control, performed by a first core network function, the method comprising:
receiving a first QoS profile sent by an access network function, wherein the first QoS profile is a QoS profile for one or more QoS flows associated with a terminal determined by the access network function from one or more alternative QoS profiles according to terminal status information of the terminal, wherein the terminal status information is configured to represent a power consumption status of the terminal; and
performing at least one of:
performing a QoS update on the one or more QoS flows associated with the terminal according to the first QoS profile;
sending the first QoS profile to a second core network function, wherein the first QoS profile is configured for the second core network function and/or an application function (AF) to perform a QoS update; or
sending the first QoS profile to the terminal, wherein the first QoS profile is further configured for the terminal to perform a QoS update.

24-26. (canceled)

27. The method according to claim 23, further comprising;
receiving the terminal status information sent by the second core network function; and
sending the terminal status information to the access network function.

28. The method according to claim 27, wherein sending the first QoS profile to the second core network function comprises:
querying subscription events to determine a first event associated with the first QoS profile; and
sending the first QoS profile to the second core network function if the first event satisfies an event reporting condition;
wherein sending the first QoS profile to the terminal comprises:
sending a non access stratum (NAS) message to the terminal, wherein the NAS message carries the first QoS profile.

29-61. (canceled)

62. A communication apparatus, comprising:
a memory that stores computer executable instructions; and
one or more processors that are communicatively coupled to the memory, wherein the computer executable instructions when collectively executed by the one or more processors cause the communication apparatus to act as the access network function and perform the method according to claim 1.

63. (canceled)

64. A communication apparatus, comprising:
a memory that stores computer executable instructions; and
one or more processors that are communicatively coupled to the memory,
wherein the computer executable instructions when collectively executed by the one or more processors cause the communication apparatus to act as the second core network function and perform the method according to claim 11.

65. A communication apparatus, comprising:
a memory that stores computer executable instructions; and
one or more processors that are communicatively coupled to the memory,
wherein the computer executable instructions when collectively executed by the one or more processors cause the communication apparatus to act as the first core network function and perform the method according to claim 23.

66. A non-transitory computer storage medium storing computer executable instructions which, when executed by a processor of the access network function, cause the access network function to perform the method according to claim 1.

67. A non-transitory computer storage medium storing computer executable instructions which, when executed by a processor of the second core network function, cause the second core network function to perform the method according to claim 11.

68. A non-transitory computer storage medium storing computer executable instructions which, when executed by a processor of the first core network function, cause the first core network function to perform the method according to claim 23.
